(19) United States
(12) Patent Application Publication
(10) Pub. No.: US 2003/0029024 A1
(43) Pub. Date: Feb. 13, 2003

(54) Commutator tool head and method

(76) Inventors: Steve P. Heitkamp, Anna, OH (US); Taggert McGough, Dayton, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 09/928,909

(22) Filed: Aug. 13, 2001

(51) Int. Cl. H01R 43/10; B23P 19/00

(52) U.S. Cl. 29/597; 29/733; 29/739; 29/596

(57) ABSTRACT

A commutator tool head for engaging a commutator having a bore and having tangs surrounding the bore. The tool head includes a substantially circular array of circumferentially-spaced-apart and commutator-tang-straightening pins. The pins are disposed substantially parallel to the longitudinal axis of the array. The pins are longitudinally positionable to enter the spaces between the tangs to engage and straighten the tangs. A method for processing a commutator includes positioning the commutator with its bore in a substantially vertical orientation and includes longitudinally aligning the commutator tool head and the commutator. By relatively longitudinally moving together the commutator and the tool head, the pins longitudinally enter the spaces between the tangs and engage and straighten the tangs.

### TECHNICAL FIELD

The present invention relates generally to commutators, and more particularly to a commutator tool head and method.

### BACKGROUND OF THE INVENTION

A commutator is an electrical component which has a bore and has tangs surrounding the bore, as is known to the artisan. Typically, a commutator is mounted on an armature shaft containing an armature core. Armatures are used in electrical devices such as electric motors and generators,

Known machines which assemble armature cores and commutators use feed systems, such as vibratory feed systems, which feed the commutators with the bores of the commutators in a horizontal position. In one known design, the machine uses fingers to push the commutator through a die member which has grooves (with lead-in beveled and flared surfaces) which straighten the tangs after which the commutator is pushed onto an armature shaft containing an armature core.

Feeding commutators with their bores horizontal has proven to be unreliable. This type of system relies on a gravity chute to transport the commutators from the vibratory bowl to the location tooling. This gravity chute itself is subject to jamming by the tangs of the horizontal commutators. There is also an unpredictable randomness to having the parts fall onto the locating dead nest tooling, as can be appreciated by those skilled in the art.

What is needed is an improved method and apparatus for processing commutators.

### SUMMARY OF THE INVENTION

A first expression of a first embodiment of the invention is a commutator tool head for engaging a commutator having a bore and having tangs surrounding the bore. The commutator tool head includes a substantially circular array of circumferentially-spaced-apart and commutator-tang-straightening pins. The array has a longitudinal axis, and the pins are positioned substantially parallel to the longitudinal axis. The pins are longitudinally positionable to enter the spaces between the tangs to engage and straighten the tangs.

A second expression of a first embodiment of the invention is a commutator tool head for engaging a commutator having a bore and having tangs surrounding the bore. The commutator tool head includes a substantially circular array of circumferentially-spaced-apart and commutator-tang-straightening pins, an expandable collet, and a ring ejector. The array has a longitudinal axis, and the pins are positioned substantially parallel to the longitudinal axis. The pins are longitudinally disposable to enter the spaces between the tangs to engage and straighten the tangs. Exactly two of the pins are commutator-rotational-alignment pins and are longer than the rest of the pins. The commutator-rotational-alignment pins are not circumferentially adjacent each other, the commutator-rotational-alignment pins are substantially identical in length, and the rest of the pins are substantially identical in length. The expandable collet is substantially coaxially aligned with the longitudinal axis. The expandable collet has an unexpanded, disengaged state and an expanded, engaged state. The expandable collet is axially positionable within the bore of the commutator in the unexpanded, disengaged state. The axially-positioned expandable collet grips the commutator from within the bore in the expanded, engaged state. The ring ejector is substantially coaxially aligned with the longitudinal axis, is longitudinally movable with respect to the pins, and is positioned to longitudinally move the gripped commutator after the expandable gripper is in the unexpanded, disengaged state.

A first method of the invention is for processing a commutator. The first method includes steps a) through d). Step a) includes obtaining a commutator tool head having a substantially circular array of circumferentially-spaced-apart and commutator-tang-straightening pins, wherein exactly one or two of the pins are commutator-rotational-alignment pins and are longer than the rest of the pins. Step b) includes positioning the commutator with the bore of the commutator in a substantially vertical orientation. Step c) includes longitudinally aligning the commutator tool head and the commutator at a first location. Step d) includes relatively longitudinally moving together the commutator and the commutator tool head so that the commutator-rotational-alignment pins engage and rotationally align the tangs of the commutator creating and maintaining commutator rotational alignment and the pins longitudinally enter the spaces between the tangs and engage and straighten the tangs.

In one example of the first method, the commutator tool head also has a gripper having an engaged state and a disengaged state, wherein during step d) the disengaged gripper enters the bore of the commutator, and the first method also includes steps e) through g). Step e) includes, after step d), engaging the gripper to grip the commutator from within the bore. Step f) includes, after step e), moving the commutator tool head with the gripped commutator to a second location which is different from the first location. Step g) includes, after step f), disengaging the gripper. In one modification of this example, the commutator tool head also has an ejector longitudinally movable with respect to the pins, and the first method also includes, after step g), the step of longitudinally moving the ejector to engage and at least partially longitudinally remove the commutator from the commutator tool head.

Several benefits and advantages are derived from the first method and/or one or both expressions of the first embodiment of the invention. The commutator tool head is used to straighten the tangs of the commutator and, in one expression, also includes commutator grip and eject features which, in the first method allows a commutator to be transferred to another location (such as one for assembling the commutator onto the armature shaft) with a tang straightening operation automatically occuring at the beginning of the transfer operation. This allows a transfer of a vertical commutator from a vibratory bowl escapement location to an armature shaft assembly location without requiring another work station location to straighten the tangs of the commutator. In the example having exactly one or two commutator-rotational-alignment pins, these longer pins first create a rotational alignment for the commutator at the first location and maintain the rotational alignment for the commutator throughout the transfer to the second location. At the second location, other tooling, also having commutator rotational alignment features, can first engage the commutator while the commutator is still on the commutator-rotational-alignment pins of the commutator tool head thus maintaining rotational alignment of the commutator for the next processing step by the other tooling (such as the step of assembly of the commutator onto an armature shaft).

### SUMMARY OF THE DRAWINGS

FIG. 1 is a schematic perspective view of a first embodiment of the commutator tool head of the invention;

FIG. 2 is a schematic tang-end view of a first embodiment of a commutator engageable by the commutator tool head of FIG. 1; and

FIG. 3 is a flow chart of the steps of a first method of the invention which employs a commutator tool head, such as the commutator tool head of FIG. 1, to process a commutator, such as the commutator of FIG. 2.

### DESCRIPTION OF THE PREFERRED EMBODIMENTS

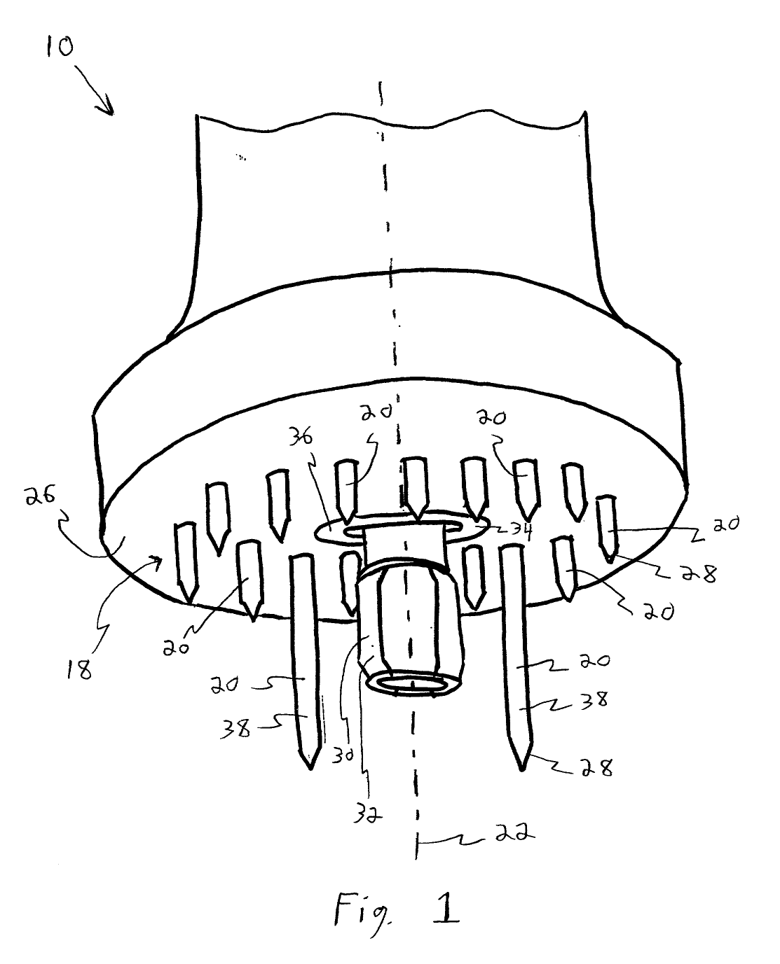

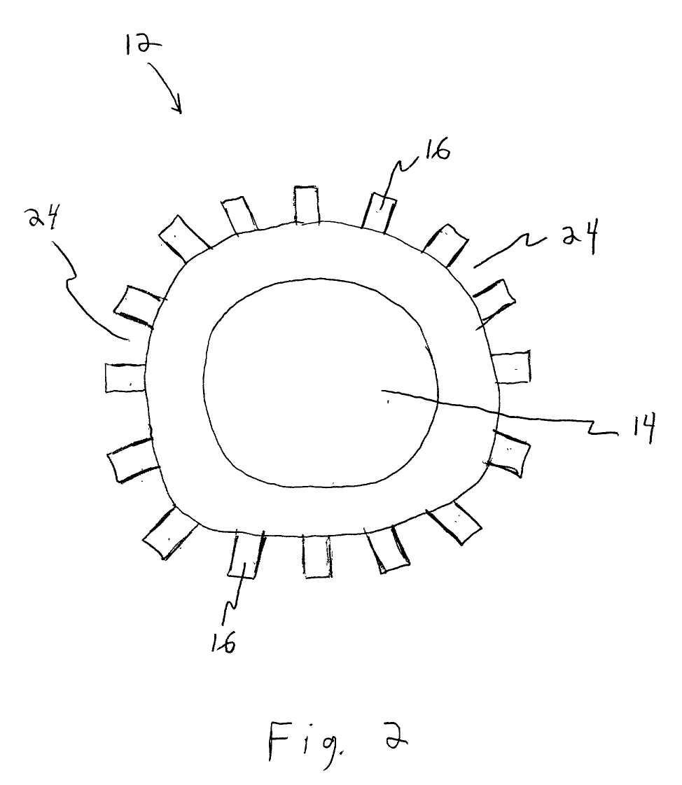

Referring now to the drawings, FIG. 1 illustrates a first embodiment of the present invention. In a first expression of the first embodiment shown in FIG. 1, a commutator tool head 10 is for engaging a commutator 12 (such as a first commutator embodiment shown in FIG. 2) having a bore 14 and having tangs 16 surrounding the bore 14. The commutator tool head 10 comprises a substantially circular array 18 of circumferentially-spaced-apart and commutator-tang-straightening pins 20. The array 18 has a longitudinal axis 22, and the pins 20 are disposed substantially parallel to the longitudinal axis 22. The pins 20 are longitudinally disposable to enter the spaces 24 between the tangs 16 to engage and straighten the tangs 16.

In one construction, the pins 20 fixedly project from a substantially planar tool head surface 26 and longitudinal movement of the commutator tool head 10 causes the pins 20 to be longitudinally disposed to enter the spaces 24 between the tangs 16 to engage and straighten the tangs 16. In another construction, the pins 20 are longitudinally movable with respect to the tool head surface 26 to project from the tool head surface 26, and longitudinal projecting movement of the pins 20 with respect to the tool head surface 26 cause the pins 20 to be longitudinally disposed to enter the spaces 24 between the tangs 16 to engage and straighten the tangs 16. In one design, the pins 20 have tapered ends 28 to facilitate engagement in the spaces 24 between the tangs 16 of the commutator 12. In another design, not shown, the pins have bullet-nose ends. In one implementation, not shown, the commutator tool head is mounted to a carriage which moves along a track from a first location to a second location. In another implementation, not shown, the commutator tool head is mounted to a robot such as a numerically-controlled three-axis mechanism.

In one example, the commutator tool head 10 also including a gripper 30, wherein the gripper 30 has an engaged state and a disengaged state. The gripper 30 is axially disposable within the bore 14 of the commutator 12 in the disengaged state, and the axially disposed gripper 30 grips the commutator 12 from within the bore 14 in the engaged state. In one design, the gripper 30 includes an expandable collet 32 substantially coaxially aligned with the longitudinal axis 22. Other designs of the gripper, not shown, are left to the artisan and include, without limitation, other frictional fit devices having engaged and disengaged states.

In the same or another example, the commutator tool head 10 also includes an ejector 34 longitudinally movable with respect to the pins 20. The ejector 34 is disposed to longitudinally move the gripped commutator 12 after the gripper 30 is in the disengaged state. In one design, the ejector 34 is a ring ejector 36 substantially coaxially aligned with the longitudinal axis 22. Other designs of the ejector, not shown, are left to the artisan and include, without limitation, longitudinally extendable and retractable rods.

In the same or another example, exactly one or two of the pins 20 are commutator-rotational-alignment pins 38 and are longer than the rest of the pins 20. In one design, exactly two of the pins 20 are commutator-rotational-alignment pins 38 and are not circumferentially adjacent ones of the pins 20. Having three or more of the pins be longer pins would interfere with the proper operation of the commutator tool head 10. In one construction, the commutator-aligning pins 38 are substantially identical in length, and the rest of the pins 20 are substantially identical in length.

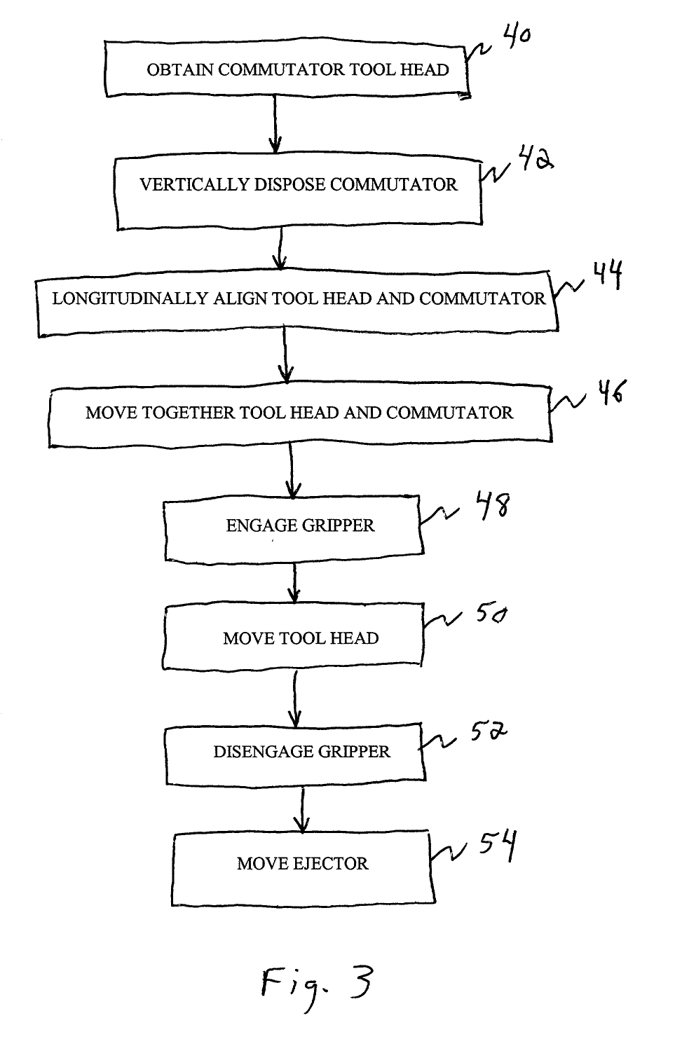

A first method of the invention is for processing a commutator 12 and is shown as a portion (blocks 40-46) of the flow chart of FIG. 3. The first method includes steps a) through d). Step a) is labeled as “Obtain Commutator Tool Head” in block 40 of FIG. 3. Step a) includes the step of obtaining a commutator tool head 10 having a substantially circular array 18 of circumferentially-spaced-apart and commutator-tang-straightening pins 20, wherein exactly one or two of the pins 20 are commutator-rotational-alignment pins 38 and are longer than the rest of the pins 20. Step b) is labeled as “Vertically Dispose Commutator” in block 42 of FIG. 3. Step b) includes the step of disposing the commutator 12 with the bore 14 of the commutator 12 in a substantially vertical orientation. Step c) is labeled as “Longitudinally Align Tool Head And Commutator” in block 44 of FIG. 3. Step c) includes longitudinally aligning the commutator tool head 10 and the commutator 12 at a first location. Step d) is labeled as “Move Together Tool Head And Commutator” in block 46 of FIG. 3. Step d) includes relatively longitudinally moving together the commutator 12 and the commutator tool head 10 so that the commutator-rotational-alignment pins 38 engage and rotationally align the tangs 16 of the commutator 12 creating and maintaining commutator rotational alignment and the pins 20 (including the commutator-rotational-alignment ones 38 of the pins 20) longitudinally enter the spaces 24 between the tangs 16 to engage and straighten the tangs 16. The sequential ordering and/or simultaneous performance of some or all of steps a) through d) are left to those skilled in the art, and it is noted that blocks 40-46 of FIG. 3 show one example of such ordering. In another example, not shown, step b) is performed before step a). Other examples are left to the artisan.

In one modification of the first method, the commutator tool head 10 also has a gripper 30 having an engaged state and a disengaged state and during step d) the disengaged gripper 30 enters the bore 14 of the commutator 12. In this modification, there is also added steps e) through g) shown as blocks 48-52 in FIG. 3. Step e) is labeled as “Engage Gripper” in block 48 of FIG. 3. Step e) includes, after step d), engaging the gripper 30 to grip the commutator 12 from within the bore 14. Step f) is labeled as “Move Tool Head” in block 50 of FIG. 3. Step f) includes, after step e), moving the commutator tool head 10 with the gripped commutator 12 to a second location different from the first location. Step g) is labeled as “Disengage Gripper” in block 52 of FIG. 3. Step g) includes, after step f), disengaging the gripper 30.

In one variation of the modified first method, the commutator tool head 10 also has an ejector 34 longitudinally movable with respect to the pins 20. In this variation, there is also added step h). Step h) is labeled as “Move Ejector” in block 54 of FIG. 3. Step h) includes, after step g), longitudinally moving the ejector 34 to engage and at least partially longitudinally remove the commutator 12 from the commutator tool head 10.

In one implementation, not shown, a vibratory bowl feeds commutators 12, with their bores 14 vertically aligned and with their tangs 16 upward, to an escapement having an end defining a first dead-nest-tooling location. A crane-type carriage is movable along a horizontal track from the first location above the first dead-nest-tooling location to a second location. The commutator tool head 10 is mounted to the carriage with the pins 20 projecting vertically downward. The expanding collet 32 is in its unexpanded, disengaged state. A ram at the first dead-nest-tooling location lifts the commutator 12 upward into engagement with the commutator tool head 10 thereby placing the expandable collet 32 inside the bore 14. The commutator-rotational-alignment pins 38 create commutator rotational alignment by their tapered ends 28 longitudinally engaging the tangs 16 which rotates the commutator 12 into alignment, if the spaces 24 between the tangs 16 do not exactly line up with the pins 20, and the commutator-rotational-alignment pins 38 thereafter longitudinally enter the spaces 24 between the tangs 16, as can be appreciated by the artisan. The commutator-rotational-alignment pins 38 create commutator rotational alignment by simply longitudinally entering the spaces 24 between the tangs 16 if the spaces 24 between the tangs 16 exactly line up with the pins 20. The pins 20, including the commutator-rotational-alignment pins 38, longitudinally enter the spaces 24 between the tangs 16 and engage and straighten the tangs 16.

In this implementation, when the pins 20 are fully engaged with the spaces 24 between the tangs 16, the expandable collet 32 is expanded to its engaged state thereby gripping the commutator 12 from within the bore 14 by gripping the wall of the bore 14. The ram is retracted, and the carriage moves the commutator tool head 10 to the second location which is above a second dead-nest-tooling location which is the vertical position of a pivoting arm mechanism also having a horizontal position for pushing the commutator 12 onto an armature shaft. The pivoting arm mechanism has commutator rotational alignment features such as two long pins not aligned with the two commutator-rotational-alignment pins 38 of the commutator tool head 10. When the pivoting arm mechanism is in the vertical position (i.e., the second dead-nest-tooling location), the expandable collet 32 is disengaged and the ring ejector 36 is longitudinally moved bringing the ring ejector 36 into engagement with the commutator 12 and longitudinally moving the commutator 12 at least partially off the pins 20. While the commutator 12 is still on the two commutator-rotational-alignment pins 38 of the commutator tool head 10 but off the rest of the pins 20, the commutator 12 also engages the two long pins of the pivoting arm mechanism thereby keeping the created commutator rotational alignment which has been maintained by the two commutator-rotational-alignment pins 38 of the commutator tool head 10 throughout the tang-straightening and commutator-transfer processing operation. Keeping commutator rotational alignment during commutator and armature assembly operations is important, as can be appreciated by those skilled in the art.

Several benefits and advantages are derived from the first method and/or one or both expressions of the first embodiment of the invention. The commutator tool head is used to straighten the tangs of the commutator and, in one expression, also includes commutator grip and eject features which, in the first method allows a commutator to be transferred to another location (such as one for assembling the commutator onto the armature shaft) with a tang straightening operation automatically occuring at the beginning of the transfer operation. This allows a transfer of a vertical commutator from a vibratory bowl escapement location to an armature shaft assembly location without requiring another work station location to straighten the tangs of the commutator. In the example having exactly one or two commutator-rotational-alignment pins, these longer pins first create a rotational alignment for the commutator at the first location and maintain the rotational alignment for the commutator throughout the transfer to the second location. At the second location, other tooling, also having commutator rotational alignment features, can first engage the commutator while the commutator is still on the commutator-rotational-alignment pins of the commutator tool head thus maintaining rotational alignment of the commutator for the next processing step by the other tooling (such as the step of assembly of the commutator onto an armature shaft).

The foregoing description of a method and several expressions of an embodiment of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. A commutator tool head for engaging a commutator having a bore and having tangs surrounding the bore, wherein the commutator tool head comprises: a substantially circular array of circumferentially-spaced-apart and commutator-tang-straightening pins, wherein the array has a longitudinal axis, wherein the pins are disposed substantially parallel to the longitudinal axis, and wherein the pins are longitudinally disposable to enter the spaces between the tangs to engage and straighten the tangs.

2. The commutator tool head of claim 1, also including a gripper, wherein the gripper has an engaged state and a disengaged state, wherein the gripper is axially disposable within the bore of the commutator in the disengaged state, and wherein the axially disposed gripper grips the commutator from within the bore in the engaged state.

3. The commutator tool head of claim 2, wherein the gripper includes an expandable collet substantially coaxially aligned with the longitudinal axis.

4. The commutator tool head of claim 3, also including an ejector longitudinally movable with respect to the pins and disposed to longitudinally move the gripped commutator after the gripper is in the disengaged state.

5. The commutator tool head of claim 4, wherein the ejector is a ring ejector substantially coaxially aligned with the longitudinal axis.

6. The commutator tool head of claim 5, wherein exactly one or two of the pins are commutator-rotational-alignment pins and are longer than the rest of the pins.

7. The commutator tool head of claim 6, wherein exactly two of the pins are commutator-rotational-alignment pins and are not circumferentially adjacent ones of the pins.

8. The commutator tool head of claim 7, wherein the commutator-aligning pins are substantially identical in length, and wherein the rest of the pins are substantially identical in length.

9. The commutator tool head of claim 2, also including an ejector longitudinally movable with respect to the pins and disposed to longitudinally move the gripped commutator after the engaged gripper is in the disengaged state.

10. The commutator tool head of claim 1, wherein exactly one or two of the pins are commutator-rotational-alignment pins and are longer than the rest of the pins.

11. The commutator tool head of claim 10, also including a gripper, wherein the gripper has an engaged state and a disengaged state, wherein the gripper is axially disposable within the bore of the commutator in the disengaged state, and wherein the axially disposed gripper grips the commutator from within the bore in the engaged state.

12. A commutator tool head for engaging a commutator having a bore and having tangs surrounding the bore, wherein the commutator tool head comprises:
a) a substantially circular array of circumferentially-spaced-apart and commutator-tang-straightening pins, wherein the array has a longitudinal axis, wherein the pins are disposed substantially parallel to the longitudinal axis, wherein the pins are longitudinally disposable to enter the spaces between the tangs to engage and straighten the tangs, wherein exactly two of the pins are commutator-rotational-alignment pins and are longer than the rest of the pins, wherein the two commutator-rotational-alignment pins are not circumferentially adjacent each other, wherein the two commutator-rotational-alignment pins are substantially identical in length, and wherein the rest of the pins are substantially identical in length;
b) an expandable collet substantially coaxially aligned with the longitudinal axis, wherein the expandable collet has an unexpanded, disengaged state and an expanded, engaged state, wherein the expandable collet is axially disposable within the bore of the commutator in the unexpanded, disengaged state, and wherein the axially disposed expandable collet grips the commutator from within the bore in the expanded, engaged state; and
c) a ring ejector substantially coaxially aligned with the longitudinal axis, longitudinally movable with respect to the pins, and disposed to longitudinally move the gripped commutator after the expandable collet is in the unexpanded, disengaged state.

13. A method for processing a commutator comprising the steps of:
a) obtaining a commutator tool head having a substantially circular array of circumferentially-spaced-apart and commutator-tang-straightening pins, wherein exactly one or two of the pins are commutator-rotational-alignment pins and are longer than the rest of the pins;
b) disposing the commutator with the bore of the commutator in a substantially vertical orientation;
c) longitudinally aligning the commutator tool head and the commutator at a first location;
d) relatively longitudinally moving together the commutator and the commutator tool head so that the commutator-rotational-alignment pins engage and rotationally align the tangs of the commutator creating and maintaining commutator rotational alignment and the pins longitudinally enter the spaces between the tangs and engage and straighten the tangs.

14. The method of claim 13, wherein the commutator tool head also has a gripper having an engaged state and a disengaged state, wherein during step d) the disengaged gripper enters the bore of the commutator, and also including the steps of:
e) after step d), engaging the gripper to grip the commutator from within the bore;
f) after step e), moving the commutator tool head with the gripped commutator to a second location different from the first location; and
g) after step f), disengaging the gripper.

15. The method of claim 14, wherein the commutator tool head also has an ejector longitudinally movable with respect to the pins, and also including the step of:
h) after step g), longitudinally moving the ejector to engage and at least partially longitudinally remove the commutator from the commutator tool head.
